(19) United States
(12) Patent Application Publication
(10) Pub. No.: US 2026/0140769 A1
(43) Pub. Date: May 21, 2026

(54) SCHEDULER

(71) Applicants: Arizona Board of Regents on behalf of Arizona State University, Scottsdale, AZ (US); Wisconsin Alumni Research Foundation, Madison, WI (US)

(72) Inventors: Chaitali CHAKRABARTI, Tempe, AZ (US); Xing CHEN, Shanghai (CN); Anish KRISHNAKUMAR, Austin, TX (US); Umit OGRAS, Madison, WI (US)

(21) Appl. No.: 19/394,738

(22) Filed: Nov. 19, 2025

Related U.S. Application Data
(60) Provisional application No. 63/723,582, filed on Nov. 21, 2024.

(51) Int. Cl. G06F 9/48

(52) U.S. Cl. CPC G06F 9/4887; G06F 9/485; G06F 9/4893

(57) ABSTRACT

A scheduler. In some embodiments, a method includes: scheduling a first task, of a first job, on a first processing element, the scheduling including: calculating a slack in the first processing element, for the first task, based on an expected occupancy time, in the first processing element, of a second task, of the first job, and based on an expected occupancy time, in the first processing element, of a third task, of a second job.

### CROSS-REFERENCE TO RELATED APPLICATION(S)

The present application claims priority to and the benefit of U.S. Provisional Application No. 63/723,582, filed Nov. 21, 2024, entitled “SCHEDULER”, the entire content of which is incorporated herein by reference.

### GOVERNMENT LICENSE RIGHTS

This invention was made with government support under FA8650-18-2-7860 awarded by the Air Force Office of Scientific Research (AFOSR). The government has certain rights in the invention.

### FIELD

One or more aspects of embodiments according to the present disclosure relate to computing with multiple processing elements, and more particularly to a scheduler for use in a system for computing with multiple processing elements.

### BACKGROUND

A computing system may include one or more processing elements connected together and configured to be able to share tasks. In such a system, it may be possible to make decisions at run time regarding which processing element a given task will execute on.

It is with respect to this general technical environment that aspects of the present disclosure are related.

### SUMMARY

According to an embodiment of the present disclosure, there is provided a method, including: scheduling a first task, of a first job, on a first processing element, the scheduling including: calculating a slack in the first processing element, for the first task, based on an expected occupancy time, in the first processing element, of a second task, of the first job, and based on an expected occupancy time, in the first processing element, of a third task, of a second job; and calculating a slack, for the first task, in a second processing element; and determining that: the difference between a slack in the first processing element and an execution time, in the first processing element, of the first task, is greater than the difference between a slack in the second processing element and an execution time, in the second processing element, of the first task, or an expected energy consumption of the first task, in the first processing element, is less than an expected energy consumption of the first task, in the second processing element.

In some embodiments, the slack in the first processing element is greater than the execution time, in the first processing element, of the first task, and the expected energy consumption of the first task, in the first processing element, is less than the expected energy consumption of the first task, in the second processing element.

In some embodiments: the slack in the first processing element is less than the execution time, in the first processing element, of the first task; the slack in the second processing element is less than an execution time, in the second processing element, of the first task; and the scheduling includes determining that the difference between the slack in the first processing element and the execution time, in the first processing element, of the first task, is greater than the difference between the slack in the second processing element and the execution time, in the second processing element, of the first task.

In some embodiments, the method further includes calculating the expected occupancy time, in the first processing element, of the second task as the product of an execution time of the second task and an allocation probability, the allocation probability being an estimated probability of the second task being allocated to the first processing element.

In some embodiments, the method further includes generating, with a neural network, the estimated probability of the second task being allocated to the first processing element.

In some embodiments, the neural network has at most two hidden layers.

In some embodiments, the neural network is fully connected. In some embodiments, the neural network is configured to receive a plurality of input features including a feature of the second task, and a feature of a cluster of processing elements including the first processing element.

In some embodiments, the method further includes providing, to the neural network, as an input feature representing execution time of the first task in a cluster of processing elements not including the first processing element, an execution time at least two times as great as a soft deadline for the first task.

According to an embodiment of the present disclosure, there is provided a non-transitory computer readable medium storing instructions that, when executed by a processing circuit, cause the processing circuit to perform a method, the method including: scheduling a first task, of a first job, on a first processing element, the scheduling including: calculating a slack in the first processing element, for the first task, based on an expected occupancy time, in the first processing element, of a second task, of the first job, and based on an expected occupancy time, in the first processing element, of a third task, of a second job; and calculating a slack, for the first task, in a second processing element; and determining that: the difference between a slack in the first processing element and an execution time, in the first processing element, of the first task, is greater than the difference between a slack in the second processing element and an execution time, in the second processing element, of the first task, or an expected energy consumption of the first task, in the first processing element, is less than an expected energy consumption of the first task, in the second processing element.

In some embodiments, the slack in the first processing element is greater than the execution time, in the first processing element, of the first task, and the expected energy consumption of the first task, in the first processing element, is less than the expected energy consumption of the first task, in the second processing element.

In some embodiments: the slack in the first processing element is less than the execution time, in the first processing element, of the first task; the slack in the second processing element is less than an execution time, in the second processing element, of the first task; and the scheduling includes determining that the difference between the slack in the first processing element and the execution time, in the first processing element, of the first task, is greater than the difference between the slack in the second processing element and the execution time, in the second processing element, of the first task.

In some embodiments, the method further includes calculating the expected occupancy time, in the first processing element, of the second task as the product of an execution time of the second task and an allocation probability, the allocation probability being an estimated probability of the second task being allocated to the first processing element.

In some embodiments, the method further includes generating, with a neural network, the estimated probability of the second task being allocated to the first processing element.

In some embodiments, the neural network has at most two hidden layers.

In some embodiments, the neural network is fully connected. In some embodiments, the neural network is configured to receive a plurality of input features including a feature of the second task, and a feature of a cluster of processing elements including the first processing element.

In some embodiments, the method further includes providing, to the neural network, as an input feature representing execution time of the first task in a cluster of processing elements not including the first processing element, an execution time at least two times as great as a soft deadline for the first task.

### BRIEF DESCRIPTION OF THE DRAWINGS

These and other features and advantages of the present disclosure will be appreciated and understood with reference to the specification, claims, and appended drawings wherein:

FIG. 1A is a table showing notation, according to an embodiment of the present disclosure;

FIG. 1B is an overview of a scheduler, according to an embodiment of the present disclosure;

FIG. 2 is a schematic illustration of a neural network, according to an embodiment of the present disclosure;

FIG. 3A is a drawing of a directed acyclic graph, according to an embodiment of the present disclosure;

FIG. 3B is a scheduling diagram, according to an embodiment of the present disclosure;

FIG. 3C is a scheduling diagram, according to an embodiment of the present disclosure;

FIG. 3D is a scheduling diagram, according to an embodiment of the present disclosure;

FIG. 3E is a scheduling diagram, according to an embodiment of the present disclosure;

FIG. 3F is a table of neural network features, according to an embodiment of the present disclosure;

FIG. 4A is a job and task diagram, according to an embodiment of the present disclosure;

FIG. 4B is a scheduling diagram, according to an embodiment of the present disclosure;

FIG. 5A is a first portion of a pseudocode listing for a scheduler, according to an embodiment of the present disclosure; and

FIG. 5B is a second portion of a pseudocode listing for a scheduler, according to an embodiment of the present disclosure.

### DETAILED DESCRIPTION

The detailed description set forth below in connection with the appended drawings is intended as a description of exemplary embodiments of a scheduler provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Heterogeneous systems-on-chip (SoCs) may bring about substantial improvements in performance and energy efficiency compared to homogeneous counterparts by leveraging the strengths of diverse processing elements (PEs) (which may be processing circuits). As a distinctive class of heterogeneous SoCs, domain-specific SoCs (DSSoCs) intelligently integrate general-purpose cores and hardware accelerators to optimize performance and energy efficiency for specific application domains. Tailoring DSSoCs for a specific domain allows designers to exploit their full potential to maximize performance and energy efficiency.

Time-sensitive applications, such as those in communications, radar, multimedia, and high-performance computing (HPC), may be expected to satisfy their soft deadlines as much as possible. A soft deadline is one that does not have to be met strictly (in contrast to a hard deadline) but failure to meet a soft deadline may incur a penalty. The penalty is associated with, for example, utility value of the results, quality of service (QoS), or monetary profit. The penalty may be measured by tardiness. An intuitive way to minimize tardiness is to run jobs on the PEs with the earliest finish time such that the jobs are completed as fast as possible, but this may result in unnecessarily high energy consumption; for example, if a deadline is long, the jobs may be run on more energy-efficient PEs and still meet the deadline, with lower energy consumption. Designing a scheduling algorithm that minimizes both tardiness and energy consumption may be challenging, especially for streaming applications, such as in radar and communications, in which multiple jobs may run on the DSSoC simultaneously.

Furthermore, jobs in the radar and communication domains, such as WiFi-TX/RX and temporal mitigation, may consist of multiple dependent tasks, which may be modeled by a directed acyclic graph (DAG). Each node in such a DAG represents a task. Soft deadline constraints are specified per application, but scheduling is performed at the task granularity level, e.g., at the granularity of each node in a DAG. Therefore, application or job-level deadlines may be translated to task-level slacks, each of which is a measure of the time available in a PE to execute a particular task. The scheduler may attempt to assign tasks to PEs that can complete their execution within the available slack. As used herein, a “slack” (which is used as a countable noun herein) is the length of a time interval available for the execution of one or more tasks or jobs, e.g., after one or more tasks (e.g., other tasks) have been allocated to PEs.

Task-level slack on a PE may depend on the tasks that are currently being executed on the PE and the unallocated tasks which will be executed on the PE in the future. The unallocated tasks compete for the same set of PEs, resulting in a decrease in the task-level slacks. In the case when multiple jobs will run simultaneously, the scheduler may be aware of the contentions from unallocated tasks within the job and across other concurrently executing jobs. These contentions may be determined if the task-to-PE allocation of the unallocated tasks can be predicted. Prior knowledge of domain applications in DSSoCs, including the DAG structure, power consumption, and execution time, may make it possible to exploit their behavior to build an accurate model to predict the allocation probability of unallocated tasks. As used herein, a “contention” is a time interval during which the PE is assumed to be unavailable for a given task because of demands made by other tasks (in the same job or in other jobs).

This disclosure describes a scheduler (which may be referred to as a Probabilistic Energy-efficient Deadline-aware (PED) scheduler) for heterogeneous DSSoCs that minimizes tardiness with the lowest energy consumption for streaming applications with soft deadline constraints. The scheduler computes the probability of different task-to-PE allocations using a neural network-based (NN-based) pre-allocation step. The allocation probabilities may be used to compute the PE occupancies due to intra- and inter-job contentions. The job-level slack may be derived from the soft deadline constraints by taking the inter-job contentions into account. Then, the task-level slack may be derived from the job-level slack by considering intra-job contentions. As used herein, a “deadline” or “soft deadline” is a time interval during which a job is expected to complete execution.

A job model for the scheduler may be constructed as follows. This disclosure considers streaming jobs with random arrival times, where each job has a soft deadline constraint. Thus, at any given time instant, there may be multiple parallel jobs in the system. The k^{th} job is represented by a directed acyclic graph (DAG) (Tₖ, Eₖ), where Tₖ is the set of nodes representing the tasks in the job and Ex denotes the set of edges, where edge e_{i,j}∈Eₖ represents the dependency between task tᵢ (parent) and task tⱼ (child). Edge e_{i,j} is annotated with the amount of data transmitted from tᵢ to tⱼ. The communication time between tᵢ and tⱼ is 0 if tᵢ and tⱼ are executed in the same PE, otherwise, it depends on the bandwidth between PEs.

The execution time of task tᵢ running on PEₘ is given by w_{i,m}. Tasks without parents are entry tasks, and tasks without children are exit tasks (if there are multiple entry/exit tasks, an additional entry/exit task with 0 latency may be added to the original multiple entry/exit tasks in the DAG, to simplify the DAG representation). For example, in a DAG with multiple entry tasks, an additional entry task with 0 latency may be added and made a predecessor to each of the entry tasks, so that the modified DAG has only one entry task. If the arrival time of job Tₖ is τₖ, then L(Tₖ), the makespan of Tₖ, is defined as the difference between τₖ and the finish time (FT) of exit task tₑₓᵢₜ∈Tₖ:

$$L ( {T}_{k} ) = F T ( {t}_{exit} ) - {τ}_{k} \qquad ( 1 )$$

The soft deadline of Tₖ is

$${D}_{k}^{soft} .$$

The tardiness of a job is defined to be the time difference between the makespan L(Tₖ) and the soft deadline, which may be computed as follows:

$${Tardiness}_{k} = max ( L ( {T}_{k} ) - {D}_{k}^{soft} , 0 ) \qquad ( 2 )$$

If a job is completed before the soft deadline

$${D}_{k}^{soft} ,$$

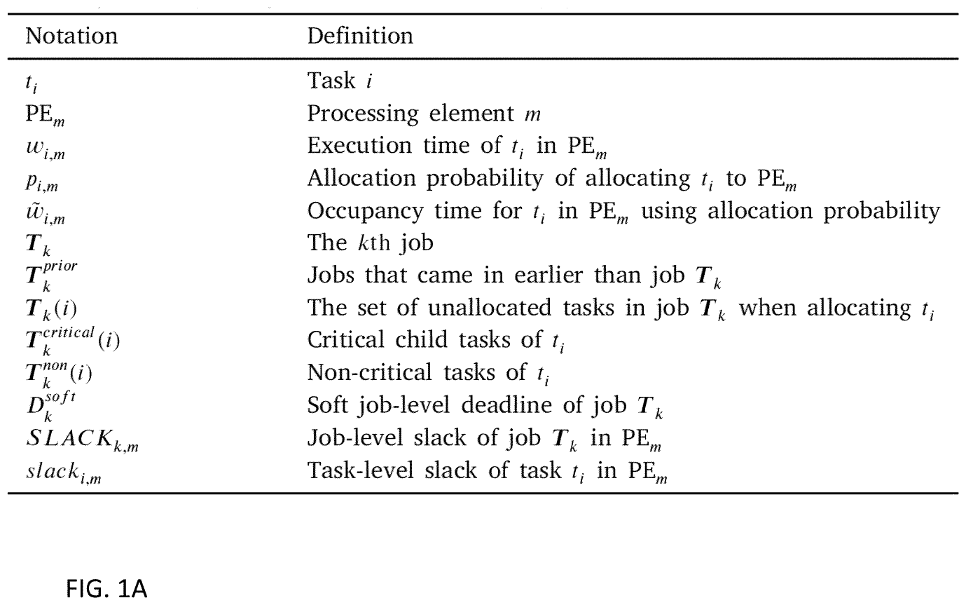

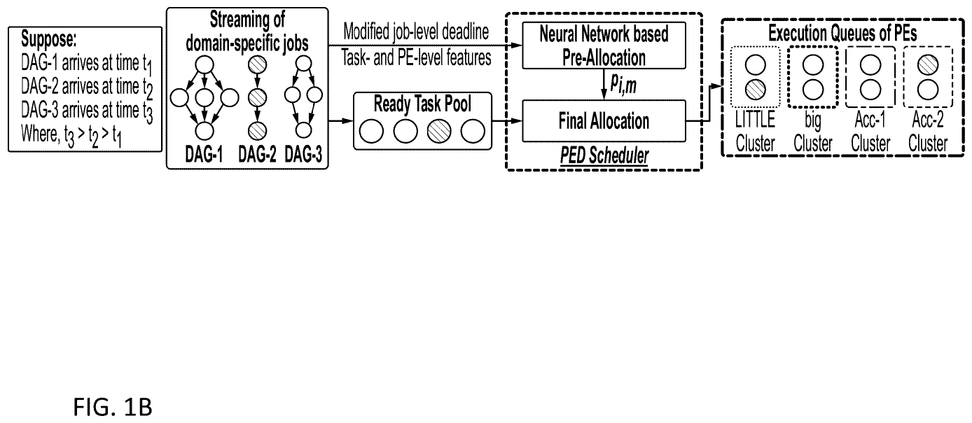

the tardiness is 0. FIG. 1A summarizes the notation used in this paper.

An SoC and energy model may be constructed as follows. In some embodiments, the domain-specific heterogeneous SoC for which the scheduler performs scheduling is a clustered multi-core system consisting of M PEs, grouped into N clusters. Each cluster consists of one or more identical PEs, which operate at the same frequency and voltage settings. For instance, the domain-specific SoC of some embodiments has five clusters, where the four ‘LITTLE’ cores form a cluster, the four ‘big’ cores form another cluster, and three types of accelerators correspond to three more clusters. While the execution time and energy of a task are the same for all PEs in a cluster, they differ from cluster to cluster. The general-purpose PEs (e.g., Arm big.LITTLE cores) may be capable of running all tasks, while the accelerators may only be capable of running specific tasks.

The total energy consumption consists of three parts:
E^{SoC-periph}: the energy from peripheral circuits of the SoC,
E^{idle}: the idle energy consumption of the PEs,
E^{active}: the energy consumption when the PEs are actively executing tasks.

Hence, the overall energy consumption of SoC is calculated using Equation 3 as:

$$\begin{matrix}E = {E}^{SoC - periph} + ( {E}^{idle} + {E}^{active} ) \\ = ( {P}^{SoC - periph} \cdot L ) + ( {\sum }_{m ∈ [ 1 , M ]} {P}_{m}^{static} \cdot {L}_{m}^{idle} ) + \\ ( {\sum }_{m ∈ [ 1 , M ]} ( {P}_{m}^{static} + {P}_{m}^{dynamic} ) \cdot {L}_{m}^{active} )\end{matrix} \qquad ( 3 )$$

where E is the overall energy consumption of K jobs, P^{SoC-periph} is a constant used to model the power of peripheral circuits, L is the time to finish K jobs, defined by the difference between the arrival time of the first job and the finish time of the last job,

$${L}_{m}^{active}$$

and

$${L}_{m}^{idle}$$

are the active and idle time period of PEₘ, respectively,

$${P}_{m}^{static}$$

is the leakage power and

$${P}_{m}^{dynamic}$$

is the dynamic power of PEₘ. The dynamic power consumption increases quadratically with voltage and the frequency increases approximately linearly with voltage:

$${P}_{m}^{dynamic} = α C {V}_{m}^{2} {f}_{m} \qquad ( 4 )$$

where α is the activity factor, C is the load capacitance, and Vₘ and fₘ are the voltage and frequency settings of PEₘ.

A problem that may be solved by the scheduler may be defined as follows. This disclosure considers randomly streaming jobs from domain-specific applications, where the DAG representation of a job is known but the arrival time of a job is not known beforehand. It may be assumed that the dynamic power of PEs, and the time and energy used to execute a task in each PE, are known beforehand. If they are not available, light-weight tools, such as simple perf and Performance Application Programming Interface (PAPI), may be used to determine the power-performance of the tasks on different PEs.

In some embodiments, the objective is to find a non-preemptive schedule S for K streaming jobs that minimizes the average tardiness (which may be a primary objective) while consuming the lowest energy E (which may be a secondary objective). It may be assumed that the K streaming jobs {T₁, . . . , T_{K}} arrive at random times {τ₁, . . . , τ_{K}} with each job having a soft deadline constraint

$$\{ {D}_{1}^{soft} , … , {D}_{K}^{soft} \} .$$

For a fair comparison of jobs with different soft deadlines, the tardiness of a job T_{K} may be normalized to its soft deadline. Thus, the average normalized tardiness of the K jobs is defined as:

$$Avg . Tardiness = \frac{1}{K} {\sum }_{k = 1}^{K} \frac{{Tardiness}_{k}}{{D}_{k}^{soft}} \qquad ( 5 )$$

Hence, the objective function may be written as:

$${min}_{𝒮 ∈ {𝒮}_{T}} E [ arg {min}_{{𝒮}_{T}} Avg . Tardiness ] \qquad ( 6 )$$

where E[ [symbol] ] is the energy consumption of schedule [symbol] , where each schedule [symbol] is defined by the task-to-PE allocation and the start time of each task. [symbol] _{T} is a set of schedules that achieve the minimum tardiness. A feasible schedule may meet the following three constraints:
Non-preemptive Constraint. A task can only be executed by one PE, i.e., the execution of a task cannot be shared by multiple PEs.
Dependency Constraint. The start time of a task tⱼ must be greater than or equal to the summation of the finish time of task t and the communication time from tᵢ to tⱼ, for any given predecessor tⱼ.
Resource Constraint. A PE can execute at most one task at a given time.

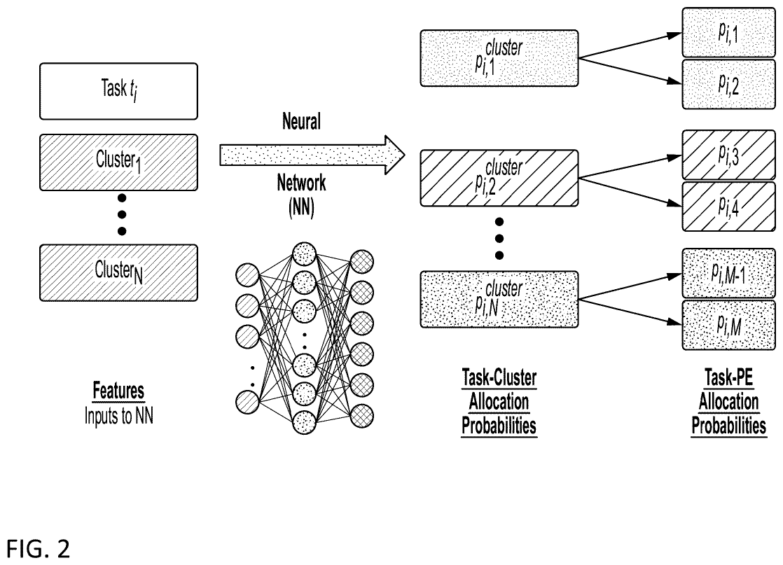

FIG. 1B shows an outline of a scheduler, in some embodiments. It includes (e.g., consists of) two steps: i) neural network-based (NN-based) pre-allocation and ii) final allocation. In FIG. 1B, the circles with different fills represent the tasks from different jobs. The pre-allocation step estimates the probability of task-to-PE allocations for all tasks in a newly arrived job. An offline-trained NN may be utilized to compute the probability of allocating a task to each of the clusters, and the task-cluster allocation probabilities may then be transformed to task-to-PE allocation probabilities, as illustrated in FIG. 2. As illustrated in FIG. 2, in some embodiments, the NN generates the task-cluster allocation probability, which is then transformed to a task-to-PE probability by scaling it with the normalized job-level slack in each PE, which is normalized by the job-level slack in each cluster. The two-step approach illustrated in FIG. 1B helps reduce the size of the NN used to derive the task-cluster allocation probability. Once the pre-allocation step has been performed, the task-to-PE allocation probability is transformed to the expected occupancy time of the task in the PE. The PE occupancy times are first used to derive the job-level slack in different PEs (denoted as SLACK_{k,m}), which is the time available in PEₘ to execute tasks in job Tₖ by considering the inter-job contentions. The job-level slack is then translated to task-level slacks for that PE by considering the intra-job contentions. Finally, the task is allocated to a PE such that the task-level slack is met with the least energy consumption. As used herein, when a task is “allocated” to a PE, it means that a final determination is made that the task will run on the PE. As used herein, when a task-to-PE allocation is “predicted”, it means that the scheduler has determined that the task is likely (but, in general, not certain) to be scheduled on the PE. As described in further detail below, the task-to-PE allocations of the tasks in a job may be predicted only once, when the job is received by the scheduler; the allocations of these tasks may be performed later.

Inter-job and intra-job contentions may be taken into account as follows. When multiple parallel jobs are to be executed simultaneously, the scheduler may take into account the contentions due to unallocated tasks in the same job (intra-job), and across jobs (inter-job).

Inter-job contention is due to other jobs competing for the same set of PEs. It reduces the job-level slack, the time available in a PE to execute the tasks in a particular job. The job-level slack SLACK_{k,m} in PEₘ may be calculated by subtracting, from the soft deadline

$${D}_{k}^{soft} ,$$

(i) the time to complete the tasks that have been allocated earlier, and (ii) the time set aside for unallocated tasks from other jobs, as discussed in further detail below.

Intra-job contention is due to the unallocated tasks in the same job competing for the same set of PEs. Like inter-job contention, intra-job contention also reduces the time available in PEs to execute a particular task. The task-level slack slack_{i,m} may be used to represent the time available in PEₘ for task tᵢ considering the intra-job contentions, as discussed in further detail below.

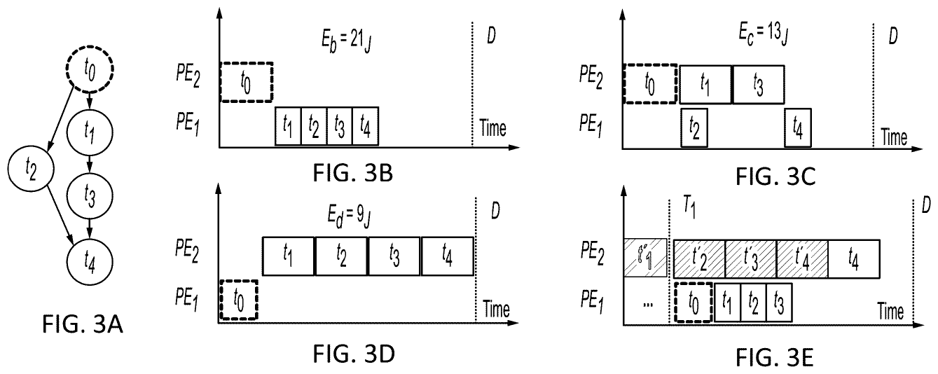

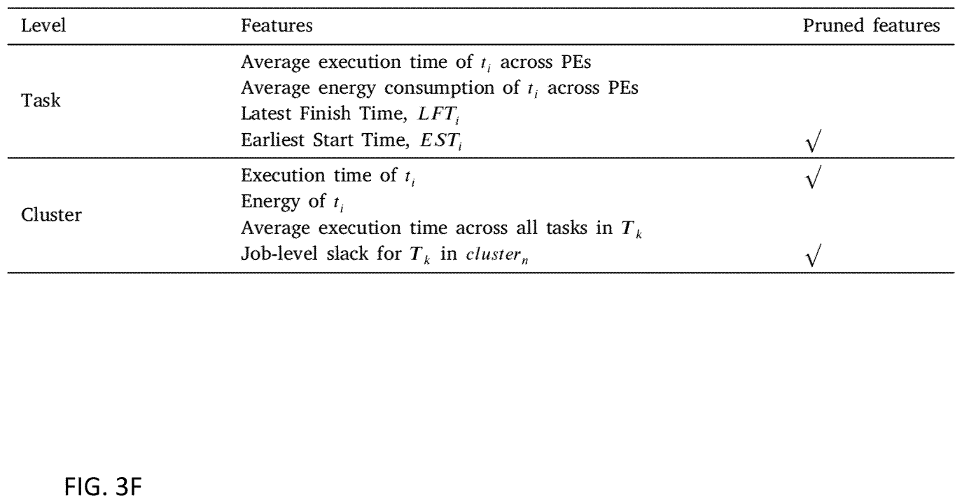

To account for the inter-job and intra-job contentions, the task-to-PE allocation of unallocated tasks may be predicted. FIG. 3A shows a DAG of job T₁ (which includes tasks t₀ to t₄), where task t₀ is to be scheduled. FIG. 3B shows a schedule with the assumption that all unallocated tasks will be allocated to PE₁. FIG. 3C shows a schedule with the assumption that unallocated tasks will be allocated to both PEs evenly. FIG. 3D shows an optimal schedule, in which the SoC executes a single job without inter-job contentions; and FIG. 3E shows an optimal schedule with inter-job contentions due to tasks in a concurrent job (job T₀, represented by the boxes with primed symbols, e.g.,

$${t}_{0}^{′} to {t}_{4}^{′} ) .$$

In the example of FIGS. 3A-3E, the job DAG (for job T₁) shown in FIG. 3A is to be allocated to two PEs. The tasks in the DAG are identical, and the execution time and energy consumption to run the task is (i) 1s and 5J in PE₁, and (ii) 2s and 1J in PE2. To schedule t₀ in T₁, the task-to-PE allocation of the unallocated tasks t₁ to t₄ may first be predicted. If the scheduler greedily assumes all unallocated tasks will be allocated to PE1, t₀ will be allocated to PE2 to minimize energy consumption since both PE1 and PE2 have enough time to execute t₀ (as shown in FIG. 3B). If the scheduler assumes unallocated tasks will be allocated to both PEs evenly, t₀ will still be allocated to PE2 (as shown in FIG. 3C). However, both schedules result in higher energy consumption than the optimal schedule in which t₀ is allocated to PE1, as shown in FIG. 3D. As such, to achieve the optimal schedule, it may be advantageous for the scheduler to be able to predict that t₁ to t₄ will be allocated to PE2. The example of FIG. 3E shows that the inter-job contention can be modeled using the prediction probability even when the tasks from competing jobs are not allocated (scheduled) yet. In the example of FIG. 3E, there is a concurrent job T₀ running in the SoC simultaneously. T₀ has the same DAG as T₁ but arrived earlier. When T₁ arrives at time τ₁, tasks

$${t}_{0}^{′} to {t}_{4}^{′} ) .$$

in job T₀ nave already been completed and the task-to-PE allocations of task

$${t}_{2}^{′} , {t}_{3}^{′} and {t}_{4}^{′}$$

have been predicted. Since the unallocated tasks in job T₀ compete with tasks in T₁ for PEs, the optimal schedule of T₁ changes as shown in FIG. 3E.

The PE occupancy due to the unallocated tasks may be estimated using the allocation probabilities generated by the NN in the pre-allocation step. Letting p_{i,m} denote the probability of allocating tᵢ to PEₘ, the probability may be transformed to the expected occupancy time of tᵢ in PEₘ using the product of the execution time and allocation probability:

$${\tilde{w}}_{i , m} = {p}_{i , m} \cdot {w}_{i , m} \qquad ( 7 )$$

where w_{i,m} is the execution time of task tᵢ running in PEₘ.

Pre-allocation based on the NN may be performed as follows. When a job with K tasks arrives, the pre-allocation step in the scheduler is evoked K times to compute the allocation probability of all tasks in the job. The allocation probability is then used to compute the expected occupancy time in different PEs as shown in Equation 7. An optimized NN may be used to calculate the allocation probability as illustrated in FIG. 2. The scheduler may use a small fully connected neural network with only one hidden layer to predict the allocation probability. The input of the NN is the feature vector set Xᵢ for task tᵢ∈Tₖ, and the output is a vector with N values representing the respective probabilities of allocating task tᵢ to each one of N clusters. The NN may be configured to generate task-cluster allocation probabilities because such a NN may have lower overhead than a NN which generates task-to-PE allocation probabilities. The output vector may be written

$${p}_{i}^{cluster} = [ {p}_{i , 1}^{cluster} , … {p}_{i , n}^{cluster} . , {p}_{i , N}^{cluster} ] = f ( {X}_{i} ) \qquad ( 8 )$$

where ƒ(⋅) is the NN function and

$${p}_{i , n}^{cluster}$$

is the probability of allocating t; to clusterₙ. Intuitively, the PE with more time available to execute tasks in a job may have a higher allocation probability. As described above, the job-level slack represents the time available to run job Tₖ considering the inter-job contentions. Thus the task-to-PE allocation probability p_{i,m} may be computed by scaling the task-cluster allocation probability with the normalized job-level slack in each PE:

$$\begin{matrix}{p}_{i , m} = \frac{job - level slack in {PE}_{m}}{job - level slack in {cluster}_{n}} \cdot {p}_{i , n}^{cluster} \\ = \frac{{SLACK}_{k , m}}{{\sum }_{P {E}_{m} ∈ c l u s t e {r}_{n}} {SLACK}_{k , m}} \cdot {p}_{i , n}^{cluster}\end{matrix} \qquad ( 9 )$$

where SLACK_{k,m} is the job-level slack in PEₘ; the detailed computation of SLACK_{k,m} is given below.

The NN may use four task-features and four cluster-features as shown in the table of FIG. 3F. The task features may include the execution time and energy consumption of a task averaged over all PEs, and the earliest start time (EST) and latest finish time (LFT) of that task. The average execution time and energy consumption give the NN a global view of the performance of the task across all PEs. The EST and the LFT are used to locate the position of the task in the DAG. The EST is the earliest time when the task may start its execution, and the LFT is the latest time at which it may be completed. Both the EST and the LFT may be calculated by assuming there is an unlimited number of resources:

$${EST}_{i} = {w}_{i , fast} + {max}_{{t}_{j} ∈ {T}_{k}^{parent} ( i )} ( {EST}_{j} + {c}_{j , i} ) \qquad ( 10 )$$

$${LFT}_{i} = {L}_{m i n} ( {T}_{k} ) - {max}_{{t}_{j} ∈ {T}_{k}^{child} ( i )} ( {LFT}_{j} + {w}_{j , fast} + {c}_{i , j} ) \qquad ( 11 )$$

where Lₘᵢₙ(Tₖ) is the minimum makespan of Tₖ corresponding to an unlimited number of resources,

$${T}_{k}^{parent} ( i ) and {T}_{k}^{child} ( i )$$

are the set of the parent and child tasks of tᵢ, w_{i,fast} is the fastest execution time of tᵢ, and c_{i,j} is the communication time between tᵢ and tⱼ.

The cluster features may include the execution time and energy consumption of task tᵢ∈Tₖ in a PE in cluster, and the execution time averaged across all tasks in Tₖ of a PE in clusterₙ. If the task cannot run in a specific cluster, its execution time may be set to be very long, e.g.,

$${w}_{i , n} = 10 \times {D}_{k}^{soft} ,$$

such that the task-cluster allocation probability will always be 0. Another cluster feature is the job-level slack in clusterₙ, defined as the sum of the job-level slack across PEs in clusterₙ:

$${SLACK}_{k , n}^{cluster} = {\sum }_{P {E}_{m} ∈ {cluster}_{n}} {SLACK}_{k , m} \qquad ( 12 )$$

Given N clusters, the total number of features is 4+4N. To minimize the runtime overhead of the NN, the number of baseline features may be pruned to one task-feature and two cluster-features using a trainable mask with regularization approach. Thus the total number of features is reduced to 1+2N after pruning. Such pruning may make run-time scheduling feasible and as such may improve the functioning of the computer itself.

NN training may be performed as follows. An optimal scheduling strategy may be implemented using, for example, the CP constraint programming optimizer (available from IBM) to generate the training dataset. CP is a search-optimization-based method that finds the optimal decision for an optimization objective given multiple constraints. Since the CP algorithm exhaustively searches the decision space, the time to run CP may be several days when there are multiple streaming jobs.

A mechanism for using a single job to generate the dataset representing multiple streaming jobs may be developed as follows. The job-level slack SLACK_{k,m} is a function of the inter-job contentions and may change at runtime. SLACK_{k,m} is also a function of the busy time of PEₘ, where busyₘ is defined as the time required to complete the allocated tasks in PEₘ. Varying busyₘ is equivalent to varying SLACK_{k,m}. Therefore, to simulate different job-level slack due to inter-job contentions, the busy time of PEₘ may be varied, to be equal to Bₘ, where Bₘ is a variable that is swept from 0 to soft deadline

$${D}_{k}^{soft} .$$

To minimize the objective function in Equation 6, the CP scheduler first finds a set of schedules S_{T} that minimize the tardiness (Tardiness). Then, among these schedules, it chooses the schedule [symbol] that minimizes the total energy consumption. The samples may be collected from different scenarios obtained by varying the frequency fₙ of clusterₙ, n∈[1, N] and busy time busyₘ of PEₘ, m∈[1, M]. The variables fₙ and busyₘ may be randomly sampled as follows:

$${f}_{n} ∼ 𝒰 ( {f}_{n}^{m i n} , … , {f}_{n}^{ma x} ) , n ∈ [ 1 , N ] \qquad ( 13 )$$

$${busy}_{m} ∼ 𝒰 ( 0 , {D}_{k}^{soft} ) , m ∈ [ 1 , M ] \qquad ( 14 )$$

where [symbol] (⋅) represents a uniform distribution, and

$${f}_{n}^{m i n} , … , {f}_{n}^{m ax}$$

is the set of an supported operating frequencies of clusterₙ.

Each training sample corresponds to a task and includes (i) its features, which are the corresponding task and cluster features, and (ii) the label, which is the cluster ID that the task is allocated to. The training samples are then used to train the NN to learn task-to-PE allocation probability on different PEs in the SoC.

Final allocation may be performed as follows. At time τ^{now}, a ready task tᵢ∈Tₖ, whose parent tasks have completed execution, is selected to be allocated. The job-level slack SLACK_{k,m} and task-level slack, slack_{i,m}, are computed for each candidate PEₘ by considering the inter-job and intra-job contentions. If w_{i,m}, the execution time of tᵢ in PEₘ, is not greater than slack_{i,m}, PEₘ is a candidate PE. Finally, tᵢ is allocated to the most energy-efficient candidate PE. If no PEs are capable of meeting the slack_{i,m} requirement, tᵢ is allocated to the PE with the minimum value of w_{i,m}−slack_{i,m}. Computing the task-level slack and identifying the most energy-efficient PE candidate for each task enables the scheduler to minimize job tardiness with the least energy consumption.

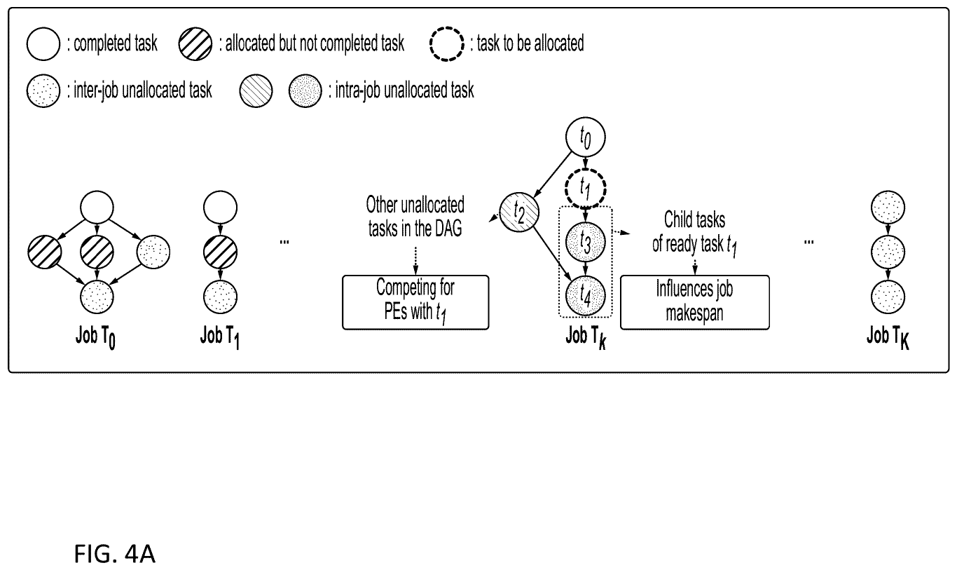

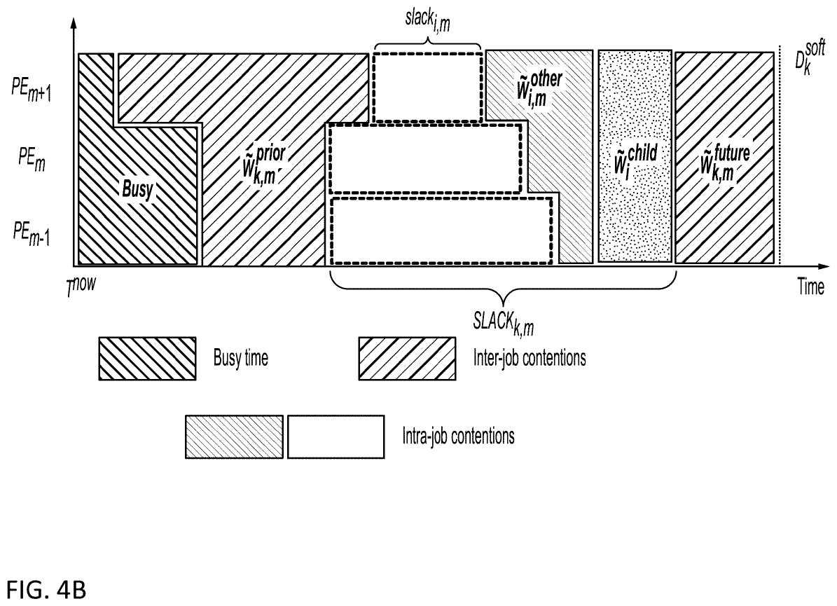

The job-level and task-level slack may be calculated as follows. FIGS. 4A and 4B illustrate an example of these calculations.

The job-level slack may be calculated as follows, considering inter-job contentions. The inter-job contentions of Tₖ arise from two types of parallel jobs, (i) jobs arriving before the current time τ^{now} (prior jobs) and (ii) jobs arriving later than τ^{now} (future jobs). The unallocated tasks from prior jobs may still be executed in PEₘ, thereby reducing the effective time of PEₘ to execute Tₖ. The occupancy times in PEₘ of the unallocated tasks from prior jobs, which is the sum of the occupancy time from unallocated tasks in prior jobs, may be calculated as:

$${\tilde{w}}_{k , m}^{prior} = {\sum }_{{t}_{i} ∈ {T}_{k}^{prior}} {\tilde{w}}_{i , m} \qquad ( 15 )$$

where

$${T}_{k}^{prior}$$

is the set of unallocated tasks from prior jobs, and \tilde{w}_{i,m} is the expected occupancy time computed in Equation 7.

This is shown in FIG. 4B, which illustrates the computation of job-level slack for job Tₖ and task-level slack for tᵢ∈Tₖ in different PEs. The job-level slack SLACK_{k,m} in PEₘ is derived by subtracting, from the soft deadline, (i) the time to complete the tasks that have been allocated earlier (busy time) and (ii) the time set aside for unallocated tasks from other prior and future jobs (inter-job contentions). The task-level slack slack_{i,m} is derived from job-level slack by subtracting the time set aside for unallocated tasks from the same job (intra-job contentions).

During the execution of Tₖ, new jobs may continue to arrive. If Tₖ has not finished by time τₖ₊₁ when Tₖ₊₁ arrives, Tₖ also competes with Tₖ₊₁ for the resources and could result in unnecessary tardiness of Tₖ₊₁. To avoid increasing the tardiness of future jobs, the occupancy time of future tasks

$${\tilde{w}}_{k , m}^{future}$$

may be considered (as illustrated in FIG. 4B). The method proposed in Chen et al. (X. Chen, U. Ogras, C. Chakrabarti, “Probabilistic risk-aware scheduling with deadline constraint for Heterogeneous SoCs”, ACM Trans. Embedded Comput. Syst. (TECS) 21 (2) (2022) 1-27) may be used to compute the occupancy of future jobs. Estimating the computation of

$${\tilde{w}}_{k , m}^{future}$$

involves estimating the arrival times of future jobs before the completion of the current job. These expected arrival times may be determined using the historical occurrence of such jobs. The presence of more future jobs leads to longer occupancy times in different PEs. Additional details are documented in Section 5.1 of Chen et al.

Equation 16 summarizes the computation for the job-level slack SLACK_{k,m} in different PEs considering the inter-job contentions:

$${SLACK}_{k , m} = {D}_{k}^{soft} - {avail}_{m} - contentio {n}_{k , m}^{inter} \qquad ( 16 )$$

where

$${contention}_{k , m}^{inter} = {\tilde{w}}_{k , m}^{prior} + {\tilde{w}}_{k , m}^{future}$$

is the estimated execution time set aside for both prior and future jobs. PEₘ is not available before completing the tasks allocated earlier; therefore, the available time of PEₘ (the time at which PEₘ will become available) is availₘ=max(τ^{now}, busyₘ), which corresponds to the region labeled “Busy” in FIG. 4B. If the unallocated tasks in parallel jobs have high allocation probability in a PE, the occupancy times in that PE may be high, resulting in a shorter job-level slack for the new job in that PE. Consequently, the tasks in the job will avoid being allocated to that PE.

Task-level slack may be calculated as follows, considering intra-job contentions. To illustrate the computation of the task-level slack, FIG. 4A presents an example of a DAG structure in which task t₁ is the ready task to be scheduled. Task t₀ is the predecessor to task t₁ which has already been completed, and tasks t₂, t₃ and t₄ are yet to be scheduled. The child path of task t₁ may be defined as a set of tasks in the branch originating from t₁ and ending at the exit task (such as t₁→t₃→t₄). The critical child path (the child path with the longest expected execution time) determines the makespan of the job. While tasks not belonging to the critical child path (such as task t₂) do not determine the makespan, they also compete for the same resources and their occupancy in PEs may therefore be considered. Therefore, the intra-job contentions of task tᵢ depend on two factors: (i) the expected execution time of the critical child path of the ready task tᵢ (the rectangle labeled

$${\tilde{w}}_{i}^{child}$$

in FIG. 4B), and (ii) the occupancy times in PEs from other tasks in the job Tₖ (the region labeled

$${\tilde{w}}_{i , m}^{other}$$

### In FIG. 4B).

The expected execution time of the critical child path may be estimated as follows. The expected time to execute every child path may be estimated by the allocation probabilities generated in the pre-allocation step and recursively computed by traversing the DAG upward starting from the exit task to tᵢ as per Equation 17:

$${\tilde{w}}_{i}^{child} = {max}_{{t}_{j} ∈ {T}_{k}^{child} ( i )} ( {𝔼}_{{w}_{j} \sim {p}_{j}} [ {w}_{j} ] + {\overline{c}}_{i , j} + {child\_path}_{j} ) \qquad ( 17 )$$

where

$${T}_{k}^{child} ( i )$$

is the set of the child tasks of tᵢ and c̅_{i,j} is the average communication cost of tᵢ and tⱼ across all PEs.

$${𝔼}_{{w}_{j} \sim {p}_{j}} [ {w}_{j} ] = {\sum }_{m ∈ M} ( {p}_{j , m} \cdot {w}_{j , m} )$$

is the expected execution time of child task tⱼ computed using its allocation probabilities pⱼ across all PEs.

$${\tilde{w}}_{i}^{child}$$

may be computed only once, when a job arrives.

Occupancy due to other tasks may be taken into account as follows. Since the child tasks in the critical child path have already been considered in

$${\tilde{w}}_{i}^{child} ,$$

the occupancy time in PES due to other non-critical tasks in Tₖ(i), which is represented as

$${T}_{k}^{other} ( i ) ,$$

may be computed. The total occupancy time in PEₘ due to non-critical tasks is

$${\tilde{w}}_{i , m}^{other} = {\sum }_{{t}_{j} ∈ {T}_{k}^{o t h e r} ( i )} {\tilde{w}}_{j , m} .$$

The task-level slack of tᵢ in PEₘ is defined as the difference between the job-level slack and the intra-job contentions:

$${slack}_{i , m} = {SLACK}_{k , m} - {contention}_{i , m}^{intra} \qquad ( 18 )$$

where

$${contention}_{i , m}^{intra} = {\tilde{w}}_{i , m}^{other} + {\tilde{w}}_{i}^{child}$$

is the total of the intra-job contentions from all unallocated tasks in Tₖ.

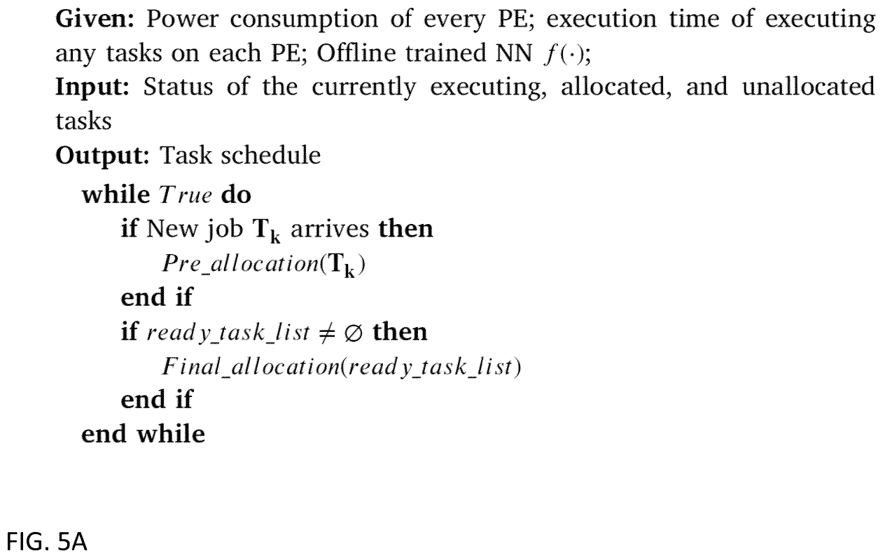

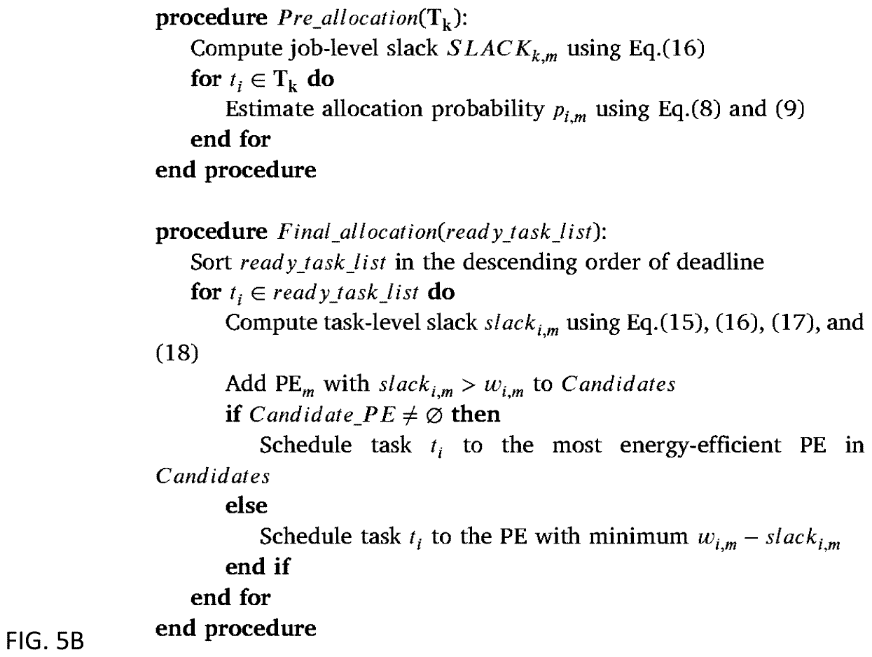

An algorithm for the scheduler is given by the pseudo-code in FIGS. 5A and 5B. When a new job Tₖ arrives, the Pre_allocation( ) step estimates the allocation probability of every task in Tₖ. When one or more tasks are ready, the Final_allocation( ) step is called to schedule the ready tasks based on their task-level slacks in the order of descending deadlines.

It will be understood that the systems and methods disclosed herein improve upon the technology of computers in various ways, for example in that they make possible the scheduling of tasks in a manner that takes into account inter-job contention, intra-job contention, and the energy consumed by the execution of the tasks. As such, systems and methods disclosed herein improve upon the operation of the computer itself.

According to an embodiment of the present disclosure, there is provided a method, including: scheduling a first task, of a first job, on a first processing element. The scheduling may include: calculating a slack in the first processing element, for the first task, based on an expected occupancy time, in the first processing element, of a second task, of the first job (e.g., based on an intra-job contention), and based on an expected occupancy time, in the first processing element, of a third task, of a second job (e.g., based on an inter-job contention); and calculating a slack, for the first task, in a second processing element; and determining that: (i) the difference between a slack in the first processing element and an execution time, in the first processing element, of the first task, is greater than the difference between a slack in the second processing element and an execution time, in the second processing element, of the first task (e.g., if the first PE is a candidate PE and the second PE is not a candidate PE, or if neither the first PE nor the second PE is a candidate PE and the first PE has the minimum value of w_{i,m}−slack_{i,m}, then the first task tᵢ may be allocated to the first PE), or (ii) an expected energy consumption of the first task, in the first processing element, is less than an expected energy consumption of the first task, in the second processing element (e.g., the first task, tᵢ may be allocated to the most energy-efficient candidate PE). Such a method may result in the ability of the system to complete one or more jobs within their respective soft deadline or to reduce the energy consumed to complete one or more jobs, and as such may improve the functioning of the computer itself.

In some embodiments, the slack in the first processing element is greater than the execution time, in the first processing element, of the first task, and the expected energy consumption of the first task, in the first processing element, is less than the expected energy consumption of the first task, in the second processing element.

In some embodiments: the slack in the first processing element is less than the execution time, in the first processing element, of the first task; the slack in the second processing element is less than an execution time, in the second processing element, of the first task (e.g., neither the first PE nor the second PE is a candidate PE); and the scheduling includes determining that the difference between the slack in the first processing element and the execution time, in the first processing element, of the first task, is greater than the difference between the slack in the second processing element and the execution time, in the second processing element, of the first task.

In some embodiments, the method further includes calculating the expected occupancy time, in the first processing element, of the second task as the product of an execution time of the second task and an allocation probability, the allocation probability being an estimated probability of the second task being allocated to the first processing element. In some embodiments, the method further includes generating, with a neural network, the estimated probability of the second task being allocated to the first processing element. In some embodiments, the neural network has at most two hidden layers. The use of a neural network, or the use of a neural network with at most two hidden layers may reduce the overhead of calculating expected occupancy times and as such, (i) help to make run time scheduling feasible, and (ii) improve the functioning of the computer itself. In some embodiments, the neural network is fully connected. In some embodiments, the neural network is configured to receive a plurality of input features including a feature of the second task, and a feature of a cluster of processing elements including the first processing element.

In some embodiments, the method further includes providing, to the neural network, as an input feature representing execution time of the first task in a cluster of processing elements not including the first processing element, an execution time at least two times as great as a soft deadline for the first task.

According to an embodiment of the present disclosure, there is provided a non-transitory computer readable medium storing instructions that, when executed by a processing circuit, cause the processing circuit to perform a method, the method including: scheduling a first task, of a first job, on a first processing element, the scheduling including: calculating a slack in the first processing element, for the first task, based on an expected occupancy time, in the first processing element, of a second task, of the first job, and based on an expected occupancy time, in the first processing element, of a third task, of a second job; and calculating a slack, for the first task, in a second processing element; and determining that: the difference between a slack in the first processing element and an execution time, in the first processing element, of the first task, is greater than the difference between a slack in the second processing element and an execution time, in the second processing element, of the first task, or an expected energy consumption of the first task, in the first processing element, is less than an expected energy consumption of the first task, in the second processing element.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Although exemplary embodiments of a scheduler have been specifically described and illustrated herein, many modifications and variations will be apparent to those skilled in the art. Accordingly, it is to be understood that a scheduler constructed according to principles of this disclosure may be embodied other than as specifically described herein. The invention is also defined in the following claims, and equivalents thereof.

What is claimed is:

1. A method, comprising:
scheduling a first task, of a first job, on a first processing element, the scheduling comprising:
calculating a slack in the first processing element, for the first task, based on an expected occupancy time, in the first processing element, of a second task, of the first job, and based on an expected occupancy time, in the first processing element, of a third task, of a second job; and
calculating a slack, for the first task, in a second processing element; and
determining that:
the difference between a slack in the first processing element and an execution time, in the first processing element, of the first task, is greater than the difference between a slack in the second processing element and an execution time, in the second processing element, of the first task, or
an expected energy consumption of the first task, in the first processing element, is less than an expected energy consumption of the first task, in the second processing element.

2. The method of claim 1, wherein the slack in the first processing element is greater than the execution time, in the first processing element, of the first task, and the expected energy consumption of the first task, in the first processing element, is less than the expected energy consumption of the first task, in the second processing element.

3. The method of claim 1, wherein:
the slack in the first processing element is less than the execution time, in the first processing element, of the first task;
the slack in the second processing element is less than an execution time, in the second processing element, of the first task; and
the scheduling comprises determining that the difference between the slack in the first processing element and the execution time, in the first processing element, of the first task, is greater than the difference between the slack in the second processing element and the execution time, in the second processing element, of the first task.

4. The method of claim 1, further comprising calculating the expected occupancy time, in the first processing element, of the second task as the product of an execution time of the second task and an allocation probability, the allocation probability being an estimated probability of the second task being allocated to the first processing element.

5. The method of claim 4, further comprising generating, with a neural network, the estimated probability of the second task being allocated to the first processing element.

6. The method of claim 5, wherein the neural network has at most two hidden layers.

7. The method of claim 5, wherein the neural network is fully connected.

8. The method of claim 5, wherein the neural network is configured to receive a plurality of input features including a feature of the second task, and a feature of a cluster of processing elements including the first processing element.

9. The method of claim 5, further comprising providing, to the neural network, as an input feature representing execution time of the first task in a cluster of processing elements not including the first processing element, an execution time at least two times as great as a soft deadline for the first task.

10. A non-transitory computer readable medium storing instructions that, when executed by a processing circuit, cause the processing circuit to perform a method, the method comprising:
scheduling a first task, of a first job, on a first processing element, the scheduling comprising:
calculating a slack in the first processing element, for the first task, based on an expected occupancy time, in the first processing element, of a second task, of the first job, and based on an expected occupancy time, in the first processing element, of a third task, of a second job; and
calculating a slack, for the first task, in a second processing element; and
determining that:
the difference between a slack in the first processing element and an execution time, in the first processing element, of the first task, is greater than the difference between a slack in the second processing element and an execution time, in the second processing element, of the first task, or
an expected energy consumption of the first task, in the first processing element, is less than an expected energy consumption of the first task, in the second processing element.

11. The non-transitory computer readable medium of claim 10, wherein the slack in the first processing element is greater than the execution time, in the first processing element, of the first task, and the expected energy consumption of the first task, in the first processing element, is less than the expected energy consumption of the first task, in the second processing element.

12. The non-transitory computer readable medium of claim 10, wherein:
the slack in the first processing element is less than the execution time, in the first processing element, of the first task;
the slack in the second processing element is less than an execution time, in the second processing element, of the first task; and
the scheduling comprises determining that the difference between the slack in the first processing element and the execution time, in the first processing element, of the first task, is greater than the difference between the slack in the second processing element and the execution time, in the second processing element, of the first task.

13. The non-transitory computer readable medium of claim 10, wherein the method further comprises calculating the expected occupancy time, in the first processing element, of the second task as the product of an execution time of the second task and an allocation probability, the allocation probability being an estimated probability of the second task being allocated to the first processing element.

14. The non-transitory computer readable medium of claim 13, wherein the method further comprises generating, with a neural network, the estimated probability of the second task being allocated to the first processing element.

15. The non-transitory computer readable medium of claim 14, wherein the neural network has at most two hidden layers.

16. The non-transitory computer readable medium of claim 14, wherein the neural network is fully connected.

17. The non-transitory computer readable medium of claim 14, wherein the neural network is configured to receive a plurality of input features including a feature of the second task, and a feature of a cluster of processing elements including the first processing element.

18. The non-transitory computer readable medium of claim 14, wherein the method further comprises providing, to the neural network, as an input feature representing execution time of the first task in a cluster of processing elements not including the first processing element, an execution time at least two times as great as a soft deadline for the first task.
